(19) United States
(12) Patent Application Publication
(10) Pub. No.: US 2013/0152744 A1
(43) Pub. Date: Jun. 20, 2013

(54) AUTOMATIC SCREW FEEDING DEVICE

(71) Applicant: Chia Chun LIU, Taichung City (TW)

(72) Inventor: Chia Chun LIU, Taichung City (TW)

(21) Appl. No.: 13/485,562

(22) Filed: May 31, 2012

(30) Foreign Application Priority Data
Dec. 19, 2011 (TW) 100147203

(51) Int. Cl. B25B 23/04

(52) U.S. Cl. 81/434

(57) ABSTRACT

An automatic screw feeding device includes a screw feeding body, a screw feeding box and a screw length adjustment seat. When a guide rod in a rear pivot hole seat of a slide base of the screw feeding box slides relative to a limit transmission trough of the screw feeding body, the guide rod in the rear pivot hole seat of the slide base of the screw feeding box will be moved downward relative to a rear displacement slot of a box body and a front pivot in a front pivot hole seat of the slide base of the screw feeding box will be moved upward relative to a front displacement slot of the box body to form a seesaw motion to push a push member pivoted to the front pivot hole seat up.

### BACKGROUND OF THE INVENTION

1. Field of the Invention

The present invention relates an automatic screw feeding device, and more particularly, to an automatic feeding device applied to a power-driven screw tool.

2. Description of the Prior Art

U.S. Pat. No. 7,950,312 discloses a screw feeding device, which comprises a first member connected to a power-driven tool and a second member movably connected to the first member. The second member has a head. The head holds against a working surface when operated. A transmission device has a rotatable axle connected with a transmission wheel to drive the screw connection plate cartridge in the track of the screw gun. A shift member has a distal end. The distal end is adjacent the head of the second member. The rotatable axle links the transmission wheel and an activating member at another head, so that the shift member moves relative to the control track of the second member to form the displacement of the transmission wheel. The second member has at least one first guide curve and at least one second guide curve. The activating member is provided behind the shift member and runs along the first guide curve of the second member. The rotatable axle is disposed in front of the shift member and runs along the second guide curve of the second member. The shift member and the second member move relative to each other, so the shift member and the transmission wheel move and switch relative to the second member. However, it has the following problems:

1. Complicated structure: The two sides of the front end of the shift member are provided with the transmission wheels to bring the screw connection plate cartridge. The configuration of the transmission wheel is complicated. The two sides of the shift member must be respectively provided with the transmission wheel, so its structure is complicated.

2. High manufacture cost: The two sides of the front end of the shift member are provided with the transmission wheels to bring the screw connection plate cartridge. The configuration of the transmission wheel is complicated. It is difficult to process and assemble the transmission wheel, which results in high manufacture cost.

Accordingly, the present invention intends to provide an automatic screw feeding device for improving the shortcomings mentioned above.

### SUMMARY OF THE INVENTION

The primary object of the present invention is to provide an automatic screw feeding device which comprises a screw feeding body, a screw feeding box and a screw length adjustment seat. A coupling portion of the screw length adjustment seat is slidably connected to a limit protruding portion of a screw access member of the screw feeding box. The outer side of the coupling portion is engaged with a positioning transmission trough of the screw feeding body. A screw length adjustment engaging plate of the screw feeding box engages with one of limit notches for adjustment of the screw length adjustment seat. When a guide rod in a rear pivot hole seat of a slide base of the screw feeding box slides relative to a limit transmission trough of the screw feeding body, the guide rod in the rear pivot hole seat of the slide base of the screw feeding box will be moved downward relative to a rear displacement slot of a box body and a front pivot in a front pivot hole seat of the slide base of the screw feeding box will be moved upward relative to a front displacement slot of the box body to form a seesaw motion to push a push member pivoted to the front pivot hole seat up. The whole configuration of a screw push unit can be simplified and the manufacture cost can be lowered.

### BRIEF DESCRIPTION OF THE DRAWINGS

FIG. 1 is a perspective view according to a preferred embodiment of the present invention;

FIG. 2 is an exploded view according to the preferred embodiment of the present invention;

FIG. 3 is an exploded view showing the screw feeding box and the screw length adjustment seat according to the preferred embodiment of the present invention;

FIG. 4 is an exploded view showing the screw push unit according to the preferred embodiment of the present invention;

FIG. 5 is a partial sectional view according to the preferred embodiment of the present invention;

FIG. 6 is a schematic view showing the first operation state according to the preferred embodiment of the present invention;

FIG. 7 is a partial enlarged view showing the first operation state according to the preferred embodiment of the present invention;

FIG. 8 is a schematic view showing the second operation state according to the preferred embodiment of the present invention;

FIG. 9 is a schematic view showing the third operation state according to the preferred embodiment of the present invention;

FIG. 10 is a partial enlarged view showing the third operation state according to the preferred embodiment of the present invention;

FIG. 11 is a partial exploded view showing screw access member according to the preferred embodiment of the present invention; and

FIG. 12 is an exploded view showing screw length adjustment seat according to the preferred embodiment of the present invention.

### DETAILED DESCRIPTION OF THE PREFERRED EMBODIMENTS

Embodiments of the present invention will now be described, by way of example only, with reference to the accompanying drawings.

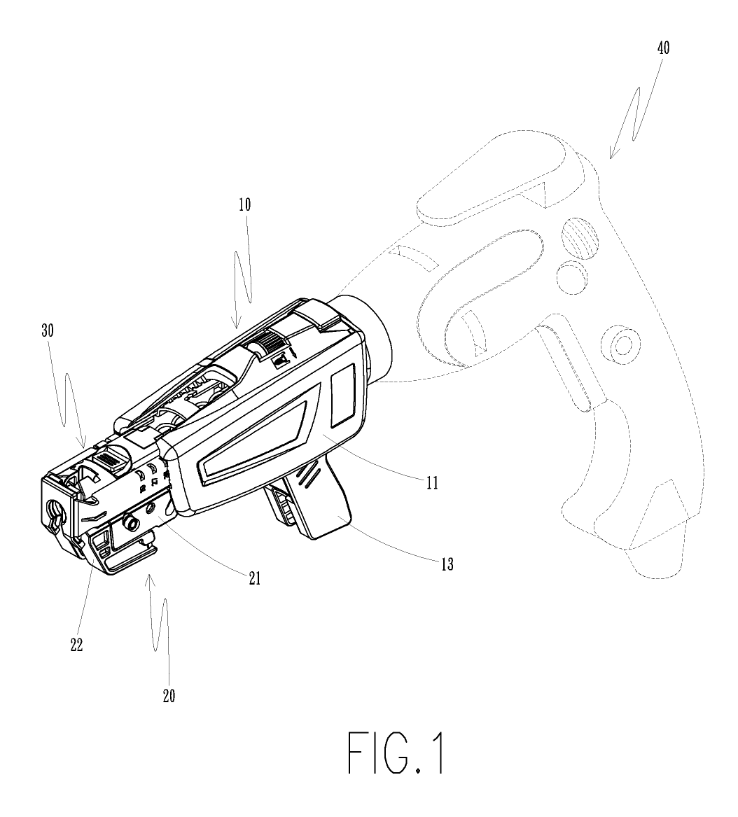

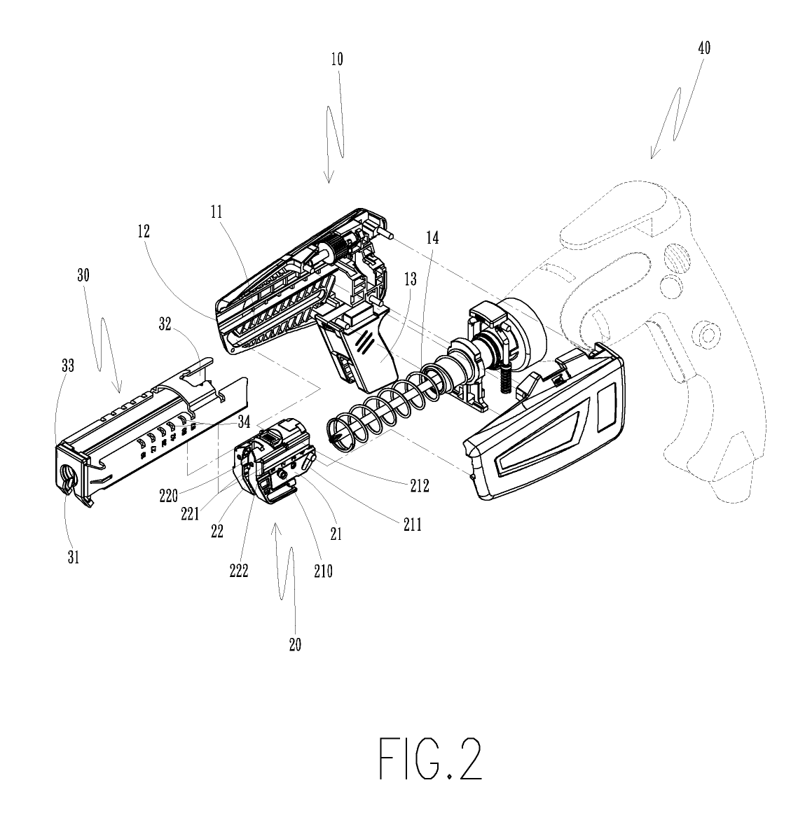

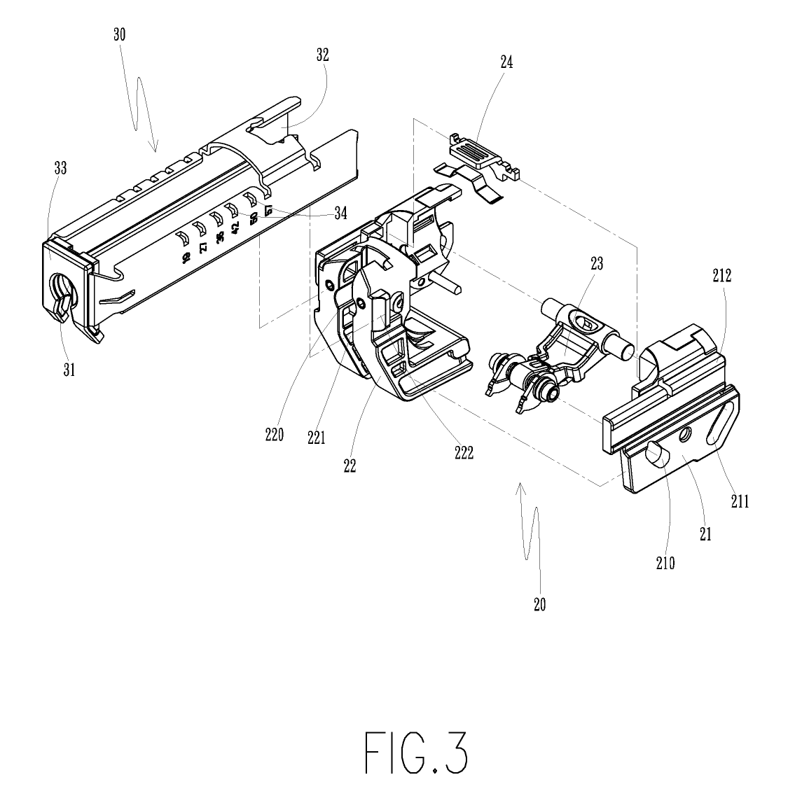

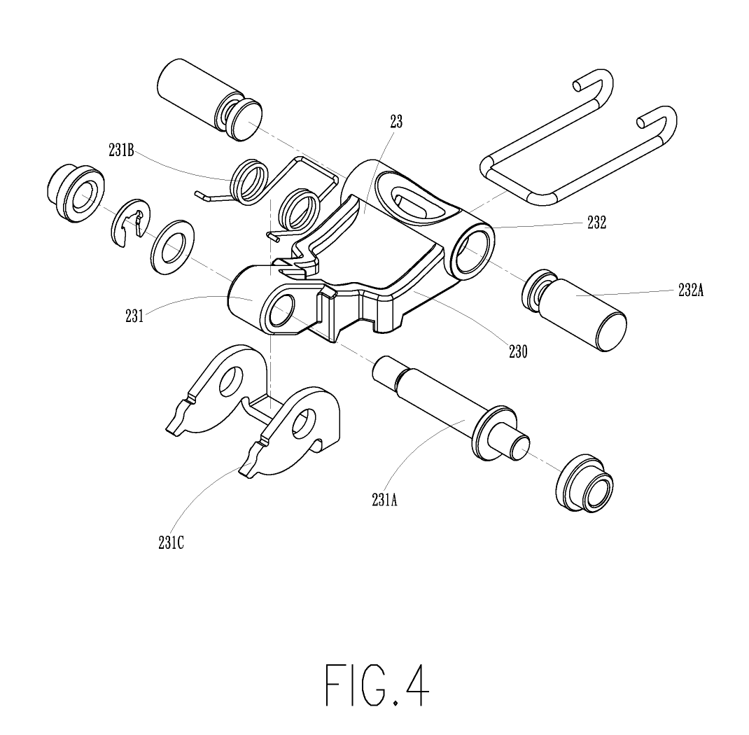

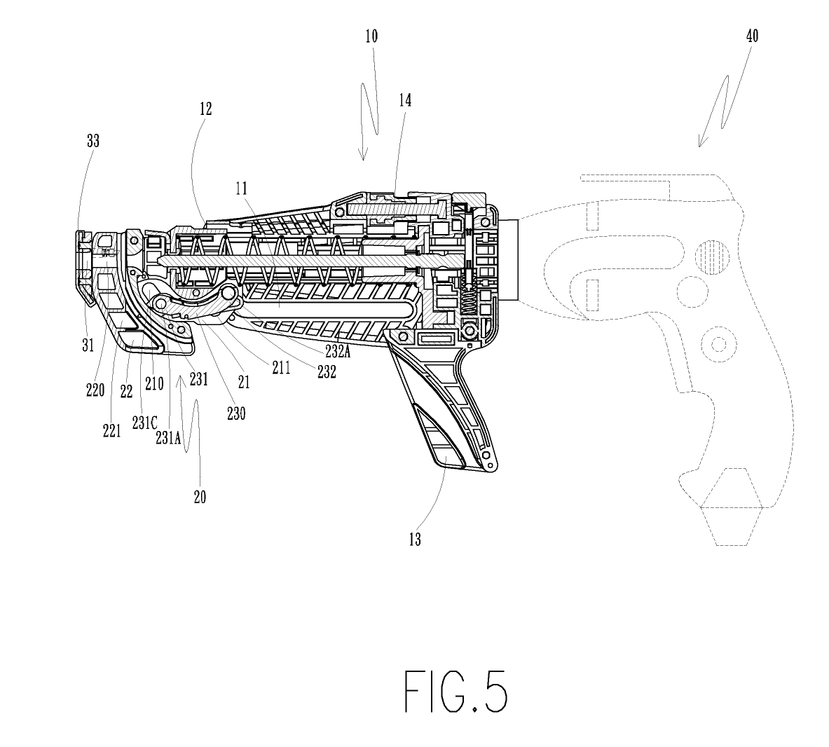

FIG. 1 is a perspective view according to a preferred embodiment of the present invention. FIG. 2 is an exploded view according to the preferred embodiment of the present invention. FIG. 3 is an exploded view showing the screw feeding box and the screw length adjustment seat according to the preferred embodiment of the present invention. FIG. 4 is an exploded view showing the screw push unit according to the preferred embodiment of the present invention. FIG. 5 is a partial sectional view according to the preferred embodiment of the present invention. As shown in FIG. 1 through FIG. 5, the automatic screw feeding device according to the preferred embodiment of the present invention comprises a screw feeding body (10), a screw feeding box (20) and a screw length adjustment seat (30).

The screw feeding body (10) has at least one limit transmission trough (11) and at least one positioning transmission trough (12) formed on an inner side thereof. The screw feeding body (10) comprises a screw cover (13) beneath a rear end thereof and a compressed spring (14) therein.

The screw feeding box (20) comprises a box body (21), a screw access member (22), a screw push unit (23) and a screw length adjustment engaging plate (24). The screw access member (22) is disposed at the front end of the box body (21). The screw push unit (23) is disposed in the box body (21). The screw length adjustment engaging plate (24) is disposed on top of the box body (21). The box body (21) has at least one front displacement slot (210) and at least one rear displacement slot (211) on a side wall thereof. The box body (21) has at least one slide portion (212) on an outer side thereof. The screw access member (22) has a screw outlet (220), a screw passage (221) under the screw outlet (220), and two limit protruding portions (222) at two upper sides thereof. The screw push unit (23) comprises a slide base (230). The slide base (230) has a front pivot hole seat (231) and a rear pivot hole seat (232) at front and rear sides thereof. The front pivot seat (231) is pivotally connected with a return elastic member (231B) and a push member (231C) through a front pivot (231A). The return elastic member (231B) has two open front ends to lean against the push member (231C). The return elastic member (231B) has a rear end to lean against the top of the front pivot hole seat (231). The rear pivot hole seat (232) is pivotally connected with a guide rod (232A). The screw feeding box (20) is disposed in the screw feeding body (10). The front pivot (231A) in the front pivot hole seat (231) of the slide base (230) is positioned in the front displacement slot (210) of the box body (21). The guide rod (232A) in the rear pivot hole seat (232) of the slide base (230) is positioned in the rear displacement slot (211) of the box body (21). The guide rod (232A) is slidable in the limit transmission trough (11) of the screw feeding body (10).

The screw length adjustment seat (30) has an outlet (31) at a front end thereof, a coupling portion (32) at a rear end thereof, and a plurality of limit notches (34) on a top thereof. The coupling portion (32) is slidably connected to the limit protruding portion (222) of the screw access member (22) of the screw feeding box (20). The outer side of the coupling portion (32) is engaged with the positioning transmission trough (12) of the screw feeding body (10). The screw length adjustment engaging plate (24) of the screw feeding box (20) engages with one of the limit notches (34).

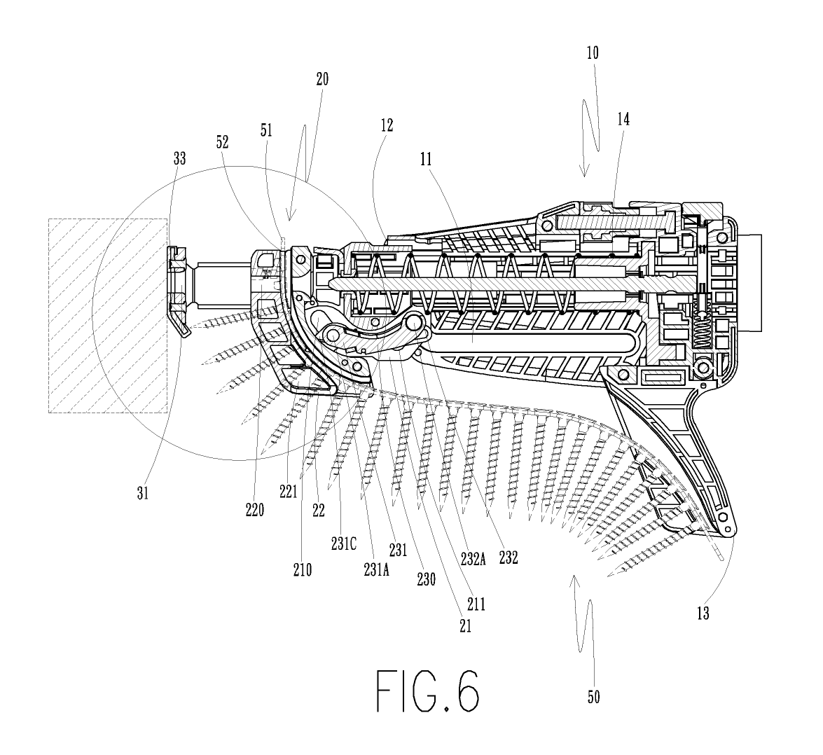

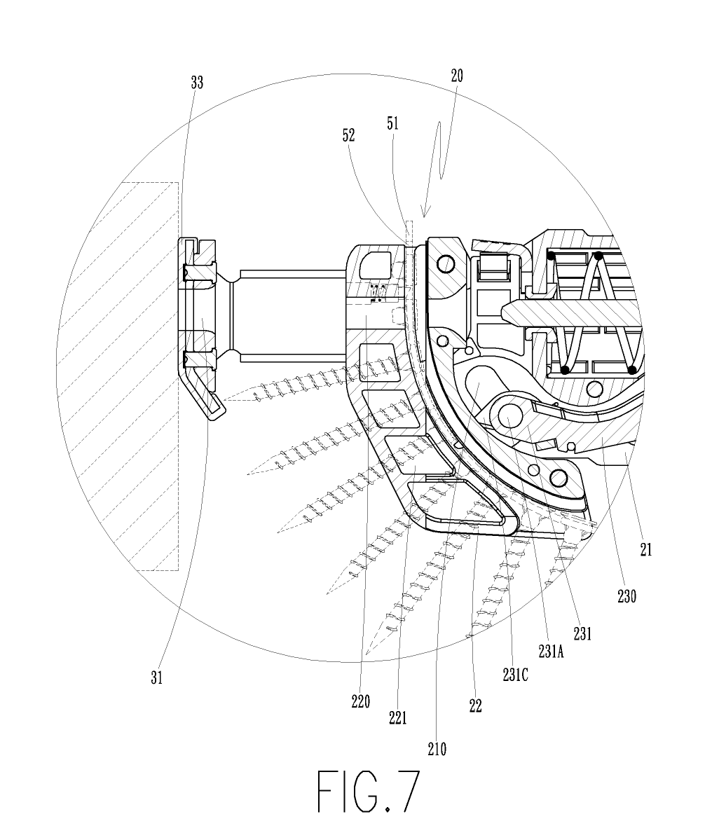

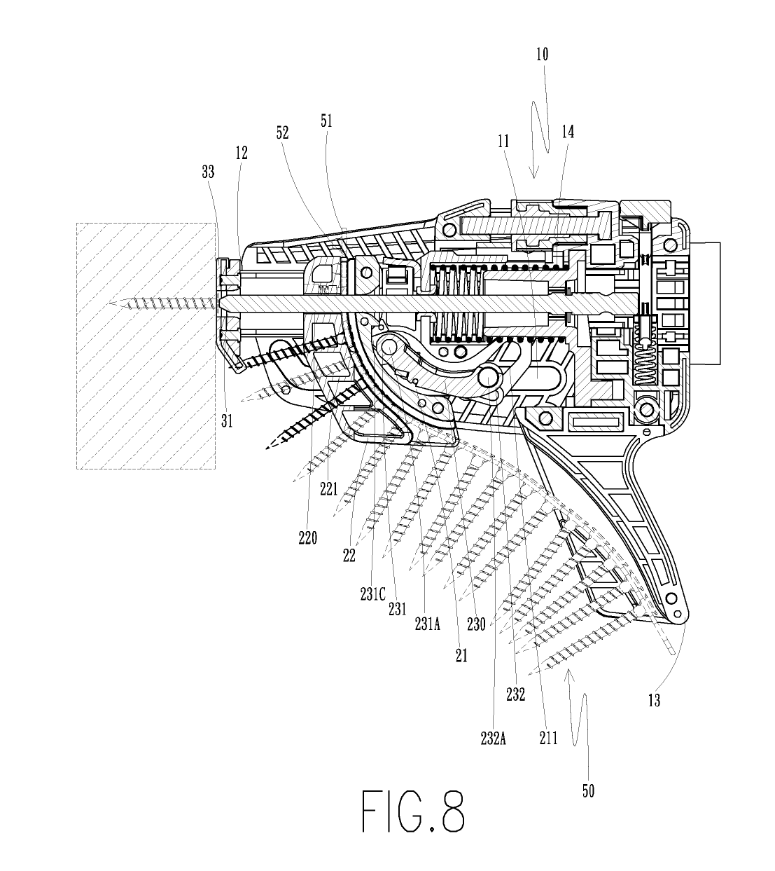

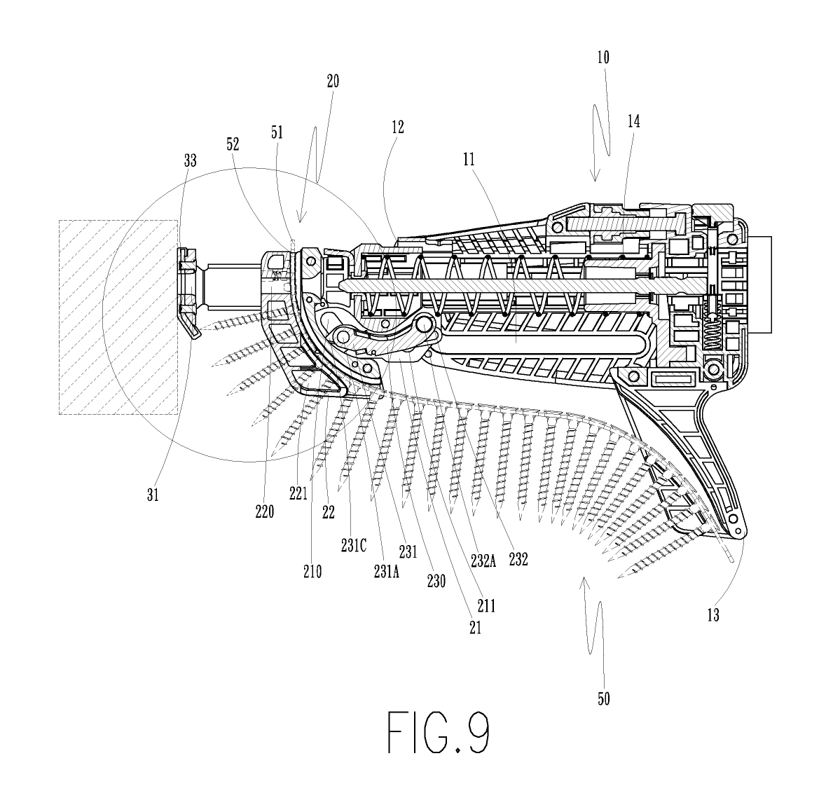

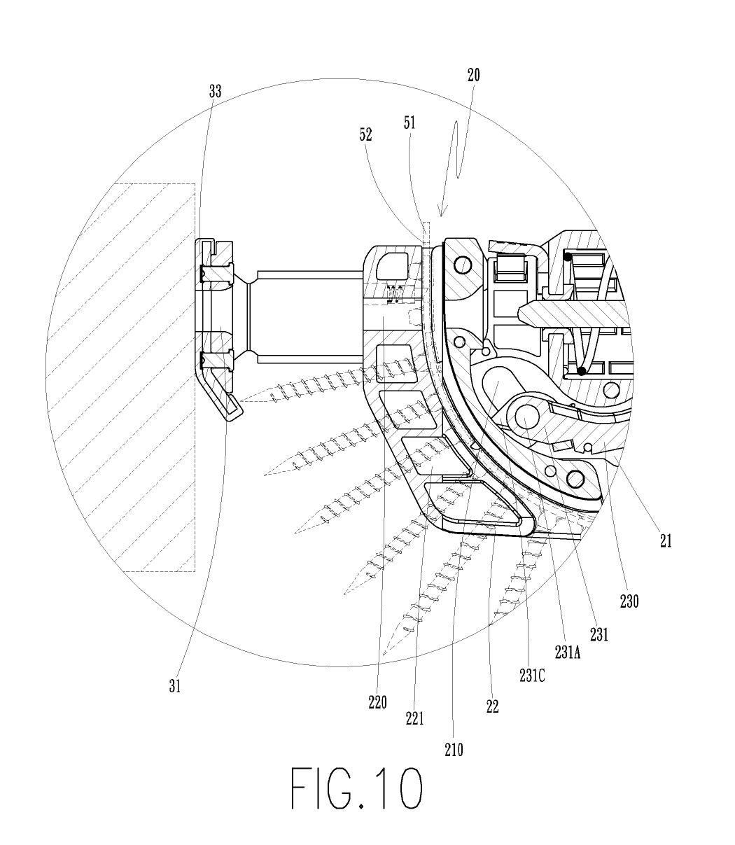

Referring to FIG. 2 through FIG. 10, the automatic screw feeding device of the present invention comprises the screw feeding body (10), the screw feeding box (20) and the screw length adjustment seat (30). The screw feeding box (20) comprises the box body (21), the screw access member (22), the screw push unit (23) and the screw length adjustment engaging plate (24). The screw access member (22) is disposed at the front end of the box body (21). The screw push unit (23) is disposed in the box body (21). The screw length adjustment engaging plate (24) is disposed on top of the box body (21). The box body (21) has at least one front displacement slot (210) and at least one rear displacement slot (211) on the side wall thereof. The box body (21) has at least one slide portion (212) on the outer side thereof. The screw access member (22) has two limit protruding portions (222) at two upper sides thereof. The front pivot seat (231) of the screw push unit (23) is pivotally connected with the return elastic member (231B) and the push member (231C) through the front pivot (231A). The return elastic member (231B) has the two open front ends to lean against the push member (231C). The return elastic member (231B) has the rear end to lean against the top of the front pivot hole seat (231). The rear pivot hole seat (232) is pivotally connected with the guide rod (232A). The front pivot (231A) in the front pivot hole seat (231) of the slide base (230) is positioned in the front displacement slot (210) of the box body (21). The guide rod (232A) in the rear pivot hole seat (232) of the slide base (230) is positioned in the rear displacement slot (211) of the box body (21). The top of the screw length adjustment seat (30) has the plurality of limit notches (34). The compressed spring (14) is connected to a screw power-driven tool (40). The coupling portion (32) of the screw length adjustment seat (30) is slidably connected to the limit protruding portion (222) of the screw access member (22) of the screw feeding box (20). The outer side of the coupling portion (32) is engaged with the positioning transmission trough (12) of the screw feeding body (10). The screw length adjustment engaging plate (24) of the screw feeding box (20) engages with one of the limit notches (34) for adjustment of the screw length adjustment seat (30). When the guide rod (232A) in the rear pivot hole seat (232) of the slide base (230) of the screw feeding box (20) slides relative to the limit transmission trough (11) of the screw feeding body (10), the guide rod (232A) in the rear pivot hole seat (232) of the slide base (230) of the screw feeding box (20) will be moved downward relative to the rear displacement slot (211) of the box body (21) and the front pivot (231A) in the front pivot hole seat (231) of the slide base (230) of the screw feeding box (20) will be moved upward relative to the front displacement slot (210) of the box body (21) to form a seesaw motion to push the push member (231C) pivoted to the front pivot hole seat (231) up. The whole configuration of the screw push unit (23) can be simplified and the manufacture cost can be lowered.

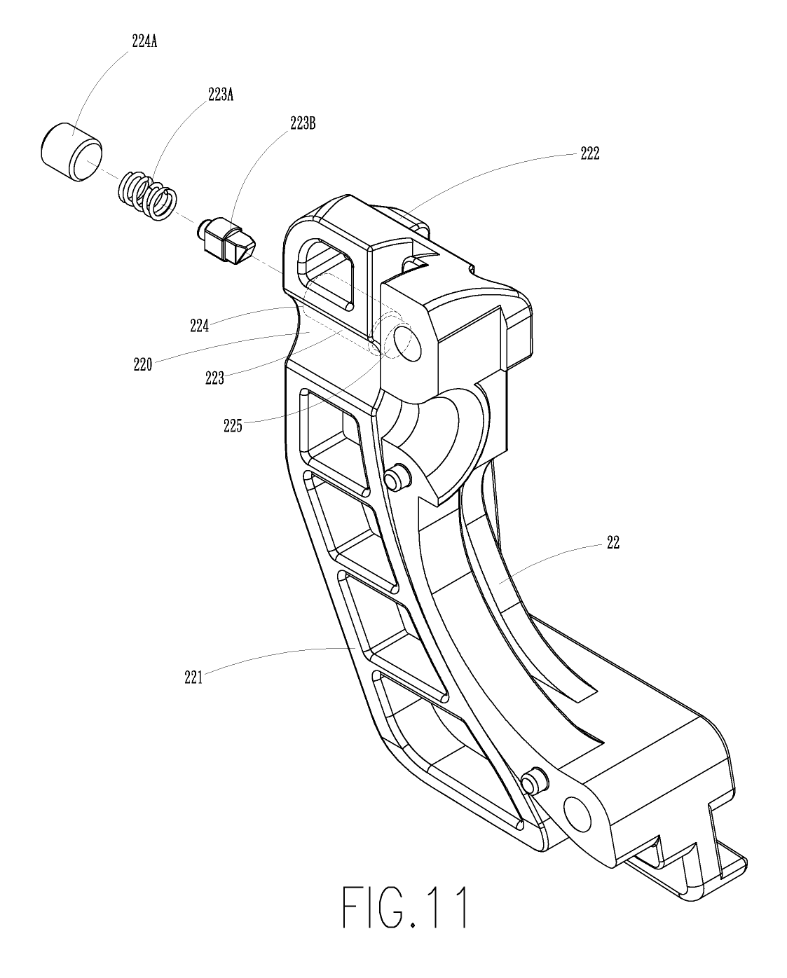

FIG. 11 is an exploded view showing the screw access member of the automatic screw feeding device. The screw access member (22) has at least one accommodation trough (223) in front of the screw outlet (220). Two ends of the accommodation trough (223) are an accommodation opening (224) and an insertion opening (225), respectively. An elastic member (223A) and a stop rod (223B) are provided in the accommodation trough (223). The end of the stop rod (223B) extends out of the insertion opening (225). A stop block (224A) is provided in the accommodation opening (224). The elastic member (223A) and the stop rod (223B) are confined in the accommodation trough (223). After all the screws of the screw unit (50) are locked, the connection plate (51) is moved upward and the end of the stop rod (223B) is against the connection plate (51). When the connection plate (51) is moved to the engaging recess (52), the stop rod (223B) biased by the elastic member (223A) will be moved forward to engage with the engaging recess (52) of the connection plate (51). When the connection plate (51) continues to move upward, the stop rod (223B) will be pushed rearward to execute continuous positioning and engagement, enhancing the practicability of the present invention.

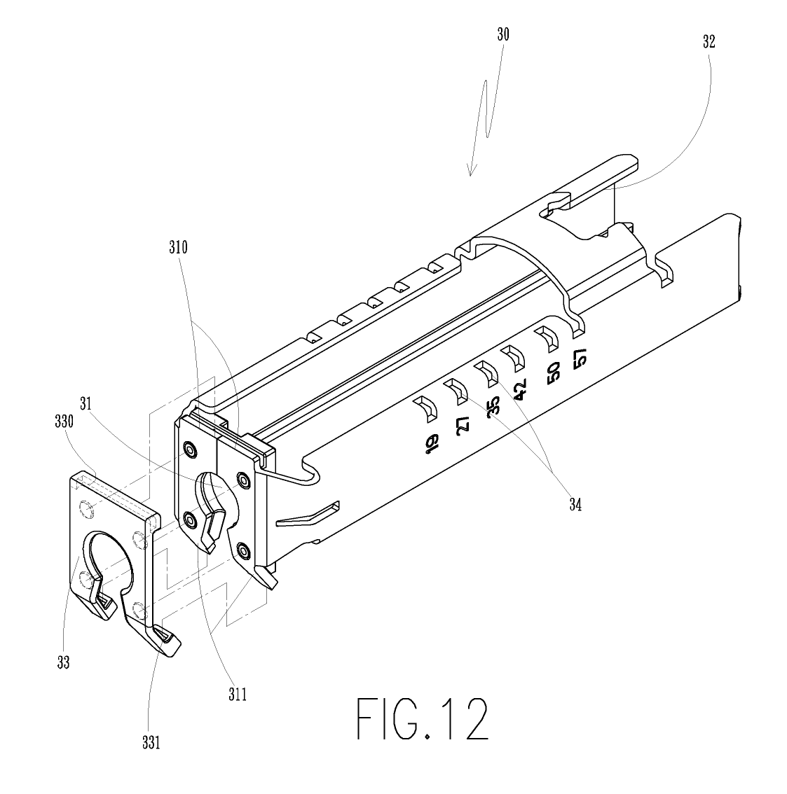

FIG. 12 is an exploded view showing the screw length adjustment seat of the automatic screw feeding device. Upper and lower ends of the outlet (31) of the screw length adjustment seat (30) respectively have a plurality of upper hooking lugs (310) and lower hooking lugs (311). A resilient cover (33) is attached to the outlet (31). Upper and lower ends of the resilient cover (33) respectively have a plurality of upper engaging grooves (330) and lower engaging grooves (331). The upper engaging grooves (330) of the resilient cover (33) engage with the upper hooking lugs (310) at the upper end of the outlet (31). The lower engaging grooves (331) of the resilient cover (33) engage with the lower hooking lugs (311) at the lower end of the outlet (31). The resilient cover (33) prevents the outlet (31) of the screw length adjustment seat (30) from being stained or damaged, enhancing the practicability of the present invention.

The advantages of the present invention are as follows:

1. Simple configuration: The screw push unit comprises the slide base. The front pivot seat of the slide base is pivotally connected with the return elastic member and the push member through the front pivot. The rear pivot hole seat is pivotally connected with the guide rod. The front pivot and the guide rod slide in the front and rear displacement slots of the box body to form a seesaw motion to push the push member pivoted to the front pivot hole seat up. The whole configuration of the screw push unit can be simplified.

2. Low manufacture cost: The screw push unit comprises the slide base. The front pivot seat of the slide base is pivotally connected with the return elastic member and the push member through the front pivot. The rear pivot hole seat is pivotally connected with the guide rod. The front pivot and the guide rod slide in the front and rear displacement slots of the box body to form a seesaw motion to push the push member pivoted to the front pivot hole seat up. The whole configuration of the screw push unit can be simplified and the manufacture cost can be lowered because the required labor power and time are reduced.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. An automatic screw feeding device, comprising:
a screw feeding body, the screw feeding body having at least one limit transmission trough formed on an inner side thereof; and
a screw feeding box, the screw feeding box comprising a box body and a screw push unit, the screw push unit being disposed in the box body, the box body having at least one front displacement slot and at least one rear displacement slot on a side wall thereof, the screw push unit comprising a slide base, the slide base having a front pivot hole seat and a rear pivot hole seat at front and rear sides thereof, the front pivot seat being pivotally connected with a push member through a front pivot, the rear pivot hole seat being pivotally connected with a guide rod, the screw feeding box being disposed in the screw feeding body, the front pivot in the front pivot hole seat of the slide base being positioned in the front displacement slot of the box body, the guide rod in the rear pivot hole seat of the slide base being positioned in the rear displacement slot of the box body, the guide rod being slidable in the limit transmission trough of the screw feeding body.

2. The automatic screw feeding device as claimed in claim 1, wherein a return elastic member is provided between the front pivot hole seat and the push member, the front pivot hole seat, the push member and return elastic member being pivotally connected by the front pivot, the return elastic member having two open front ends to lean against the push member, the return elastic member having a rear end to lean against a top of the front pivot hole seat.

3. The automatic screw feeding device as claimed in claim 1, wherein the screw feeding box comprises a screw access member at a front end of the box body, the screw access member having a screw outlet and a screw passage under the screw outlet.

4. The automatic screw feeding device as claimed in claim 3, wherein the screw access member has at least one accommodation trough in front of the screw outlet, two ends of the accommodation trough being an accommodation opening and an insertion opening, an elastic member and a stop rod being provided in the accommodation trough, an end of the stop rod extending out of the insertion opening, a stop block being provided in the accommodation opening, the elastic member and the stop rod being confined in the accommodation trough.

5. An automatic screw feeding device, comprising:
a screw feeding body, the screw feeding body having at least one limit transmission trough and at least one positioning transmission trough formed on an inner side thereof, the screw feeding body comprising a compressed spring therein;
a screw feeding box, the screw feeding box comprising a box body and a screw push unit, the screw push unit being disposed in the box body, the box body having at least one front displacement slot and at least one rear displacement slot on a side wall thereof, the screw push unit comprising a slide base, the slide base having a front pivot hole seat and a rear pivot hole seat at front and rear sides thereof, the front pivot seat being pivotally connected with a push member through a front pivot, the rear pivot hole seat being pivotally connected with a guide rod, the screw feeding box being disposed in the screw feeding body, the front pivot in the front pivot hole seat of the slide base being positioned in the front displacement slot of the box body, the guide rod in the rear pivot hole seat of the slide base being positioned in the rear displacement slot of the box body, the guide rod being slidable in the limit transmission trough of the screw feeding body; and
a screw length adjustment seat, the screw length adjustment seat having an outlet at a front end thereof and a coupling portion at a rear end thereof, upper and lower ends of the outlet of the screw length adjustment seat respectively having a plurality of upper hooking lugs and lower hooking lugs, a resilient cover being attached to the outlet, upper and lower ends of the resilient cover respectively having a plurality of upper engaging grooves and lower engaging grooves, the upper engaging grooves of the resilient cover engaging with the upper hooking lugs at the upper end of the outlet, the lower engaging grooves of the resilient cover engaging with the lower hooking lugs at the lower end of the outlet, the coupling portion being slidably connected to the screw access member of the screw feeding box, an outer side of the coupling portion being engaged with the positioning transmission trough of the screw feeding body.

6. The automatic screw feeding device as claimed in claim 5, wherein a return elastic member is provided between the front pivot hole seat and the push member, the front pivot hole seat, the push member and return elastic member being pivotally connected by the front pivot, the return elastic member having two open front ends to lean against the push member, the return elastic member having a rear end to lean against a top of the front pivot hole seat.

7. The automatic screw feeding device as claimed in claim 5, wherein the screw feeding box comprises a screw access member at a front end of the box body, the screw access member having a screw outlet, a screw passage under the screw outlet.

8. The automatic screw feeding device as claimed in claim 7, wherein the screw access member has at least one accommodation trough in front of the screw outlet, two ends of the accommodation trough being an accommodation opening and an insertion opening, an elastic member and a stop rod being provided in the accommodation trough, an end of the stop rod extending out of the insertion opening, a stop block being provided in the accommodation opening, the elastic member and the stop rod being confined in the accommodation trough.
